(19) United States
(12) Patent Application Publication
(10) Pub. No.: US 2004/0009814 A1
(43) Pub. Date: Jan. 15, 2004

(54) Whole-body controlling apparatus for fight game

(76) Inventor: Sung-Ha Kim, Seoul (KR)

Correspondence Address: Stephen M De Klerk, Blakely Sokoloff Taylor & Zafman, Seventh Floor, 12400 Wilshire Boulevard, Los Angeles, CA, 90025, US

(21) Appl. No.: 10/363,000

(22) PCT Filed: Jul. 21, 2001
(86) PCT No.: PCT/KR01/01246

(30) Foreign Application Priority Data
Aug. 31, 2000 (KR) 2000/51163

(51) Int. Cl. A63F 13/00

(52) U.S. Cl. 463/36

(57) ABSTRACT

The present invention is related to a whole body control device for combat game that is good for the health as every part of the user's body is used and being exercised while enjoying the game, and it comprises a foot regulator (36) to control the movement of the image appeared in the game by foot, a curtain-type left-side sensing section (8) having left-side sensing regions (14), (16) formed on left-side of the front of said foot regulator initiating its operation when the user stretches out his/her arms or feet, and a curtain-type right-side sensing section (28) having right-side sensing regions (12), (20) formed on right-side of the front of said foot regulator (36) initiating its operation when the user stretches out his/her arms or feet.

### TECHNICAL FIELD

The present invention concerns a whole-body controlling system for combat game, more particularly a whole-body control system for combat game that can improve health by exercising the entire part of the game user's body using his/her body while enjoying the game.

### BACKGROUND ART

Generally, most electronic games are designed so the game users sit to play the games, and the current circumstance reveals that the game users are using controller attached to the game system with only their hands and head to enjoy the game.

However, the recent trend shows that simple games requiring only hand movement are disappearing due to variety of games and a high leap of technical ideas.

In other words, games elevated into a game for diet such as Dance Dance Revolution (DDR) using the entire body parts are largely thriving.

The DDR game involves a method of enjoying the game while dancing using leg movement. The game has a controller at the feet plate regulator detecting the foot movement which increases the exercise level. Thus, the effect of the exercise can be heightened still more.

Moreover, nowadays it has been developed that not only the foot movement but also the hand movement are involved to enjoy the game.

Yet, such detectors of the above games using infrared rays to detect hands lead to an awkward movement due to a simple movement in a state of just reaching out hands to touch when game user is in use. Thus, the games have a problem which causes an imbalance in exercise.

### DETAILED DESCRIPTION

Accordingly, the present invention was created in consideration of the conventional problem such as those mentioned above, and its object is to provide a whole-body controlling system for combat game which can increase the exercise amount {level} of the entire body using arms and legs as well as increase interest in the electronic game due to use of the whole body.

In order to achieve the aforementioned object, the present invention furnishes as one of aspects, a curtain-type sensing means forming a shielding screen detecting the movement of the hands and feet stretched at the front of the feet plate regulator to regulate the movement of image appearing on the monitor of the game by feet.

According to the present system, the game user should pass the curtain type sensing unit at the front of the feet plate regulator in order to proceed the game so the increased effect of the exercise can be achieved.

Moreover, the sensing means provides a upper curtain-type sensing signal generator at the upper side and a lower curtain-type sensing signal generator at the lower sides.

As aforementioned, since the sensing signal generators are formed at the upper and lower sides, the hand movement and kicking movement by feet can be simultaneously applied to the game rendering an effect of increasing the movement further more.

Also, between the upper curtain-type sensing signal generator and lower curtain-type sensing signal generator, a shielding unit for prohibiting successive movement is provided which detects when the game user moves with his arms and legs stretched.

By the shielding unit for prohibiting successive movement, the game user is prevented from swinging movement with arms or legs that are not being moved appropriately but in a stretched state so the game user's exercise movement is appropriately guided to achieve further exercise effect.

Further, the sensing means is formed on the left side of the feet plate regulator (36) and on the right side of a left curtain type sensing signal generator (8) having left sensing area to be operated at the stretch of game user's hands and feet and right side of the feet plate regulator (36). The means provides a right side curtain type sensing signal generator (28) having right sensing area to be operated at the stretch of game user's hands and feet.

The sensing means is installed at the left and right sides so the game user can enjoy the game and exercise by stretching the left and right arms alternatively.

A shielding unit for prohibiting successive movement (22) is provided between the right side curtain type sensing signal generator (28) and the left side curtain type sensing signal generator (8).

As the shielding unit for prohibiting successive movement (22) is provided between the right side curtain type sensing signal generator (28) and the left side curtain type sensing signal generator (8), the game user can prevent {himself from} the swinging movement with hands, etc. in a stretched state, and can increase the exercise effect.

The right side curtain type sensing signal generator (28), left side curtain type sensing signal generator (8), and shielding unit for prohibiting successive movement (22) are provided with a transmission type optical sensor, a feedback reflection type optical sensor or a diffusion reflection type optical sensor.

As such sensors are used, not only the reaction rate by movement is fast but also the sensing areas in curtain-type can be widened so the effect wherein the signals by exercise movement is further well generated can be achieved.

The right side curtain type sensing signal generator (28) is divided into a upper right side curtain type sensing signal generator (26) and a lower right side curtain type sensing signal generator (30), and the curtain type sensing signal generator (8) is divided into a upper left side curtain-type sensing signal generator (32) and a lower left side curtain-type sensing signal generator (6).

As aforementioned, the signal generation area is divided into 4 regions. Thus, an effect of further concretely realizing the game movement due to possible generation of left and right arms or feet movement from four areas can be achieved.

The shielding unit for prohibiting successive movement (22) is provided any one of between the upper right side curtain type sensing signal generator (26) and lower right side curtain type sensing signal generator (30) or between the upper left side curtain type sensing signal generator (32) and the lower left side curtain type sensing signal generator (6).

When swinging the arms and feet in a stretched state, the sensor of the shielding unit for prohibiting successive movement is operated and signals thereof are generated to prohibit movement of image on the monitor. Thus, the game user is to do the correct movement again, which increases the exercise effect.

The sensing means is provided with a curtain type sensing signal generator (44) having a right-side lower sensing area and a left-side sensing area formed at the lower front of the feet plate regulator (36) to be operated at the time the game user stretches his hands or feet.

As the sensing means is formed on the lower-side, the game user cannot view the frame of the sensing means at the front-side. Therefore, an effect of eliminating the feeling of rejection can be obtained.

Also, on the left-side of the feet plate regulator (36), a lower left side sensing signal generator (6) having a lower left-side sensing area to be operated by the left foot movement is installed. On the right-side, a lower right side sensing signal generator (30) having a lower right-side sensing area to be operated by the right foot movement is provided.

As aforementioned, the sensing areas are formed at the lower sides of the right and left sides in order to smoothly generate the signals at the left and right sides kicking movement of feet.

The shielding unit for prohibiting successive movement is provided in any one of the lower left side curtain type sensing signal generator (6) and the lower right side curtain type sensing signal generator (30).

Accordingly, the invention does not allow making a swinging movement with the stretched feet by the shielding unit for prohibiting successive movement so the stretched feet should be folded again and stretched out again for operation. Thus, the amount of feet exercise can be increased.

The curtain-type sensing signal generator (44) is composed of a upper left-side sensor signal generator (40) and a upper right-side sensor signal generator (42), and the shielding unit for prohibiting successive movement (22) is provided therebetween.

According to the sensing signal generator (44) formed at the lower-side, the operation {of the game triggered by} the awkward movement when detecting the arm movement is controlled, which can also increase the exercise amount of the arms.

The curtain-type sensing signal generator (44), and the lower left side curtain type sensing signal generator (6) and the lower right side curtain type sensing signal generator (30) are provided with a transmission type optical sensor or a diffusion reflection type optical sensor.

The sensor forms a curtain-type shielding screen not only for game users to smoothly lead movement but also to achieve an effect which enables enjoyment of the combat game identical to the actual combat.

Moreover, a sensor is provided so that either the curtain-type sensing means of the present invention is formed overlapped in double layers or a light transmitting unit and a light receiving unit of the curtain-type sensing means overlapped in double layers are operated crossing each other in X-form.

Since the curtain-type sensing means is formed overlapped in double layers as aforementioned, more clear signals can be generated at the game user's movement so the fun of the game can be further more multiplied.

Meanwhile, the feet plate regulator provides a running machine having a revolution speed detecting sensor.

As aforementioned, the revolution speed detecting sensor is attached to the running machine and being used so the game user can jog in an on-game state while enjoying the game. Thus, the exercise amount can be further multiplied.

### BRIEF DESCRIPTION OF DRAWINGS

FIG. 1 is a drawing showing a whole-body controlling system for combat game of the present invention.

FIG. 2 is a drawing showing the state of its use when the whole-body controlling system for combat game of the present invention uses a transmission type optical sensor.

FIG. 3 is a drawing showing an example of a variation of the whole-body controlling system for combat game of the present invention.

FIG. 4 is a drawing showing the state of the dually built whole-body controlling system for combat game of the present invention.

FIG. 5 is a drawing showing a feet plate regulator that is a running machine among the whole-body controlling system for combat game of the present invention.

FIG. 6 is a block diagram showing the whole-body controlling system for combat game of the present invention.

### BEST MODE FOR CARRYING OUT THE INVENTION

A whole-body controlling system for combat game of the present invention is described in details as below:

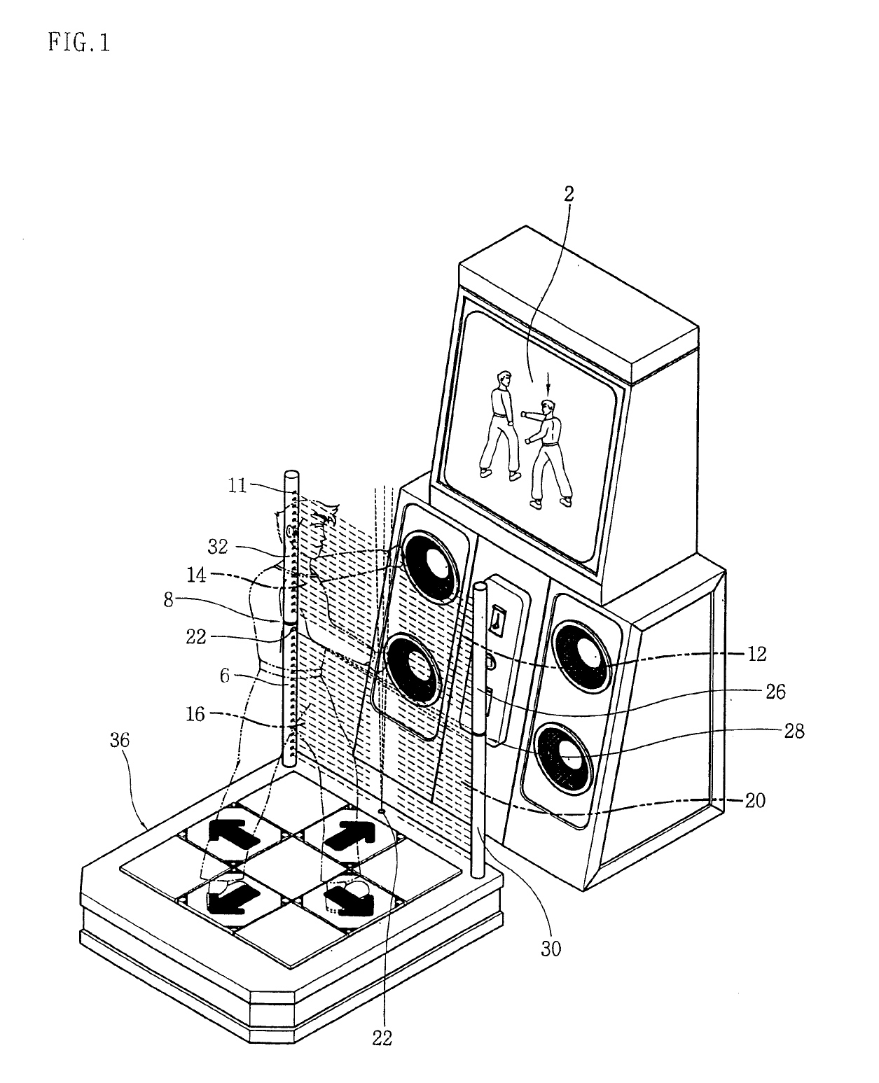

FIG. 1 is a drawing showing a whole-body controlling system for combat game of the present invention.

The whole-body controlling system for combat game of the present invention such as FIG. 1 is comprised of a mainframe having a monitor at the front (2), and operated by using arms and legs of the game user to enjoy the game while watching the visual image appearing on the monitor (2).

As the system is operated using arms and legs, the game user playing the game exercises one's whole body and enjoy the combat game, etc.

The controlling system of the present invention uses a feet plate regulator (36) used in DDR game commonly sold at the market on the floor of the front side of the game machine monitor (2).

The feet plate regulator (36) for game machine contains a curtain-type area portion in comprising a shielding screen at the front side of the feet plate regulator (36) which detects the arms and legs at their stretch in order to detect the movement of game user in intention to enjoy the game.

The curtain type sensing area is split into a upper curtain-type sensing signal generator and a lower curtain type sensing signal generator.

After forming a curtain-type sensing area at the front side of the feet plate regulator (36) of the present invention, signals are generated when the front curtain-type sensing area is touched. The present invention is characterized in that such feature is applicable to the game.

The present invention can be applied to game, etc. that can generate and transmit two kinds of signals if divided into two sensing areas by a upper curtain-type sensing signal regulator and a lower sensing signal regulator in the feet plate regulator (36).

Furthermore, the feet plate regulator (36) of the present invention is adapted not only to use game user's feet solely but also to use hands and feet simultaneously in order to operate the visual image appearing on the monitor (2) identical to the game user's movement.

The feet plate regulator (36) of the present invention is comprised of a demarcated sensing areas allowing movements such as punching, kicking, etc. in order to render { [symbol] z,900 } action to figure image of a subject appearing on the monitor (2) of the game machine.

The demarcated sensing areas detect by a curtain screen adapted to sense when the game user swings fists or kicks within the sensing areas.

The signals sensed from the above movement are not illustrated. However, after they are transmitted to main board through control section, the sensed state can be adapted to move around the figure image appearing on the monitor of the game machine.

The left/right sides of the front of the feet plate regulator (36) include sensing areas, and the sensing areas can be comprised of two sensing areas in the upper side or lower side in order to either use left/right sides feet plates such as in boxing or to detect only feet movement such as in soccer.

Moreover, it is of course possible to divide the sensing areas into 4 in order to respectively sense the game user's left hand and right hand, and left foot and right foot when they are stretched.

In other words, as illustrated in FIG. 1, the left side sensing area is comprised of a upper left side sensing area (14) and a lower left side sensing area (16) in order to sense the left hand and left foot, and the right side sensing area is comprised of a upper right side sensing area (12) and a lower right side sensing area (20) in order to sense the right hand and right foot.

Such sensing areas of the present invention make a sensing area of curtain screen such as a shielding screen in the air, and a left side curtain-type sensing signal generator (8) sensing left hand and left foot movement is formed and generates signals at the front side of the feet plate regulator (36).

Also, in the right side, a right side curtain-type sensing signal generator (28) is adapted widely in order to sense right hand and right foot movement and emits signals so that when hands, etc. penetrate the sensing signal generators, a signal change of the sensing signal generators occurs and motions are rendered to image of the figure appearing on the monitor (2).

Further, the respective left side curtain-type sensing signal generator (8) and right side curtain-type sensing signal generator (28) are divided into two as upper side and lower side to sense the arms and feet movement respectively, which are constituted in division of a upper left side sensing signal generator (32) and a lower left side sensing signal generator (6), and a upper right side sensing signal generator (26) and a lower right side sensing signal generator (30).

Since the sensing signal generators constituted as above are structured long in a pole form, the curtain-type sensing area is characterized to be constituted as much wider in planar dimension.

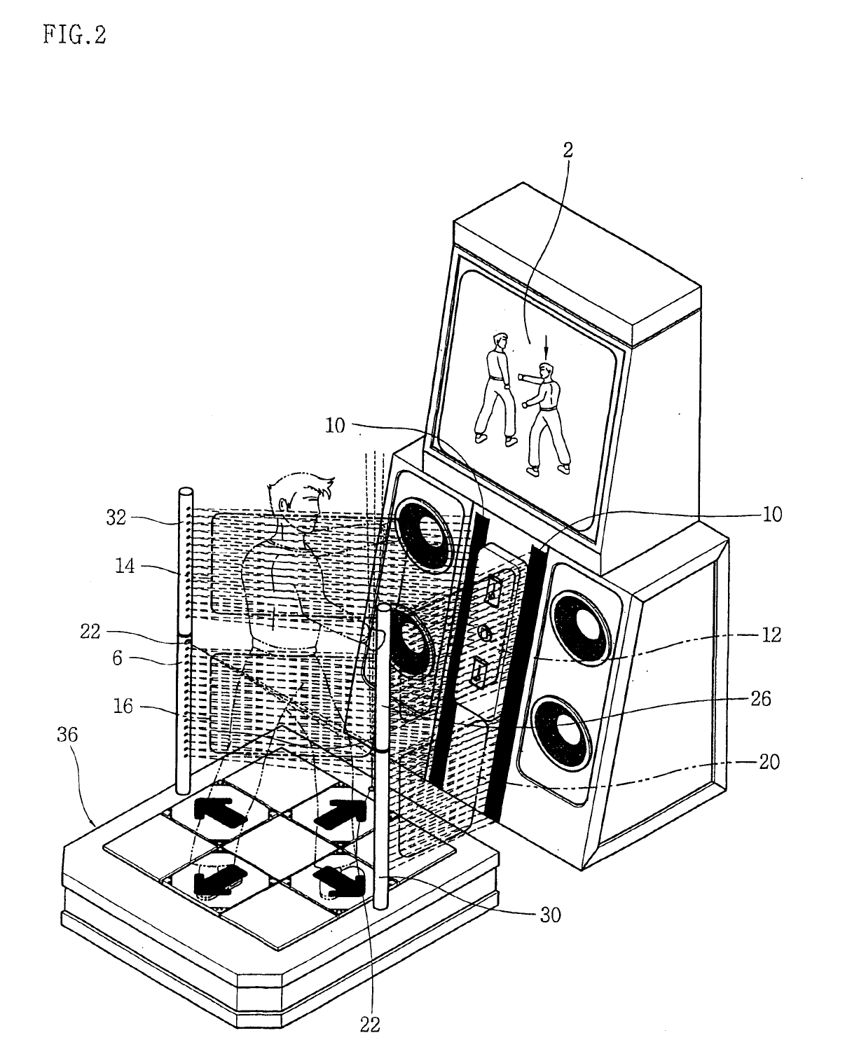

FIG. 2 is a drawing showing the state,of its use when the whole-body controlling system for combat game of the present invention uses a transmission type optical sensor.

As illustrated in FIG. 2, the portion of the sensing areas of the upper left side sensing signal generator (32) and {upper} right side sensing signal generator (26) can be constituted in the rear portion of the feet plate regulator in order to reach the sensing areas without bending the body when arms or feet are stretched.

As the sensing areas are installed by moving to the rear to fit the length of the arm of the game user's body, etc., the operation can be carried out without game user's body being extremely bent forward.

In other words, as constituted according to the FIG. 2, the portion of the sensing areas (12) (14) of the upper side curtain screen is constituted near to the direction of the game user's body so the movement of arms or feet can be more easily detected.

The device used in the above sensing signal generator is a commonly used optical sensor, etc. which can sense the movement of the game user's motion fast.

Among the optical sensors such as the above, the present invention uses those that contain a transmission type optical sensor, a feedback reflection type optical sensor or a diffusion reflection type optical sensor.

The front side of the feet plate regulator (36) is characterized in that the sensor unit is not installed to an arbitrary object in a single piece in order to move the figure image appearing on the monitor.

Also, since the sensing areas of the curtain screen are constituted using light emitted by an optical sensor installed on the sides or lower sides, etc., the present invention is constituted not to create resistance over the installation of a single piece object (for example, sandbag, etc.) having sensor in front of the game user.

The optical sensor, etc. used as the above is constituted to detect change during transmission and receipt of the arbitrary signals.

When using a transmission type optical sensor as in FIG. 2, the light receiving unit (10) and the light emitting unit (11) are used, which constitute square shaped sensing areas. Thus, the state of sensing when regulating game is characterized to be very high.

Accordingly, as depicted in FIGS. 1 and 2, the sensing areas are divided into parts and are operating individually so that when game user's movement such as punching with left fist, etc. penetrates the upper left side sensing area (14) of the curtain screen made in the front, the upper left side curtain-type sensing signal generator (32) is operated at that moment. The signals are transmitted to the control unit (not illustrated) and the movement of image of the figure, etc. appearing on the monitor is correspondingly rendered thereto.

At this moment, in case of the optical sensor used in FIG. 2, a light emitting unit (11) and a light receiving unit (10) are separately constituted. In other words, the main body containing monitor comprises a light receiving unit (10), and the feet plate regulator (36) comprises a light emitting unit (11).

Further, when the game user using the right fist swings to penetrate the upper right side sensing area (12), the upper right side sensing signal generator (26) detects the right fist movement and transmits to the control unit signals rendering the same movement to the fist appearing as image of a figure on the monitor.

The left and right feet movement is operated identically as the left and right fist movement. When kicking using the left and right feet at the lower left side sensing area (16) formed by the lower left side sensing signal generator (6) constituted in the front lower side of the feet plate regulator (36) and the lower right side sensing area (20) formed by the lower right side sensing signal generator (30), signals are generated at the penetration of the lower left sensing area (16) or lower right sensing area (20) by the feet. Such movement is detected and signals for moving the figure image appearing on the monitor (2) identically as the movement of the game user are transmitted.

Moreover, between the left side curtain-type sensing signal generator (6) and the right side curtain-type sensing signal generator (30), a shielding unit for prohibiting successive movement (22) is constituted. Thus, even moving by swinging movement successively to the right and left when the feet are stretched, the shielding unit for prohibiting successive movement (22) constituted in the middle blocks [such movement}.

Hence, as aforementioned, even the game user assumes the swinging movement without moving the body, the left side curtain type sensing signal generator (8) and the right side curtain type sensing signal generator (28) are not operated.

That is, in order to prevent a swinging movement to the right and the left of the left fist in a stretched state after being drawn out without being folded back, the shielding unit for prohibiting successive movement (a swinging movement when fists are stretched without being folded back) (22) is constituted in the central portion of the left side curtain-type sensing signal generator (8) and the right side curtain-type sensing signal generator (28).

Therefore, when movement is detected at the shielding unit for prohibiting successive movement (22) by swing hands and feet to the left and to the right, the upper left side sensing area (14) detects such movement and is operated. Afterwards, it is transferred to the upper right side sensing signal generator (26). The movement is detected by the shielding unit for prohibiting successive movement (22) and by the upper right side sensing signal generator (26) so {it is} not operated.

In addition, it is, of course, possible to constitute the shielding unit for prohibiting successive movement (22) between the upper left side sensing signal generator (32) and lower left side sensing signal generator (16) in order to prevent successive skills of the movement swinging up and down when hands are stretched.

The shielding unit for prohibiting successive movement (22) is constituted to detect movement in the sensing areas since the sensor lines of the curtain screen emitted in the vertical direction create sensing areas in the penetration area as illustrated.

The shielding unit for prohibiting successive movement (22) prevents the awkward swinging movement when waving up and down without bending the fists or feet that are in a stretched state.

Accordingly, the game user can constitute the shielding unit for prohibiting successive movement (22) in a crisscross pattern between the upper left side sensing area (14), the lower left side sensing signal generator (16), and the upper right side sensing area (12), lower right side sensing area (20). Thus, after making an accurate movement of stretching arms and feet, an accurate movement of folding the stretched arms and feet should be performed again, and the stretching movement should follow again in order to generate signals that can move images appearing on the monitor. In this regard, the present invention is characterized to increase exercise amount further to the game user to such extent.

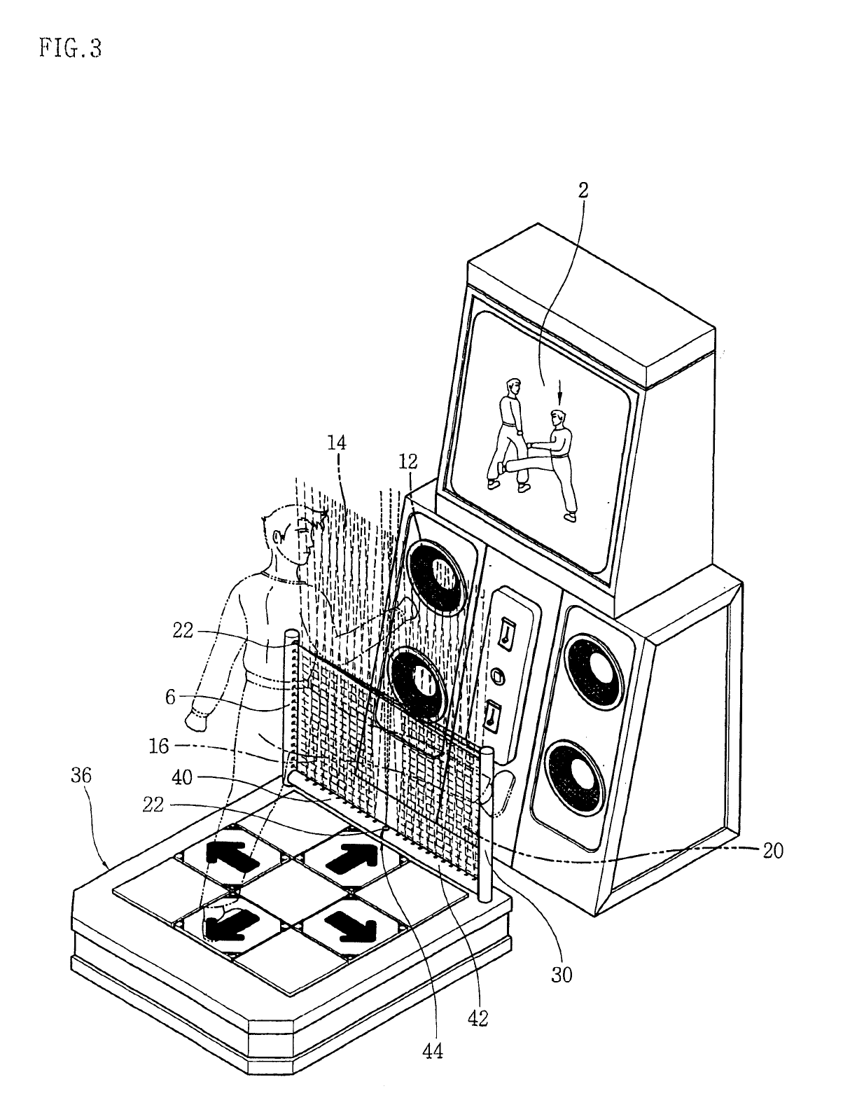

FIG. 3 is a drawing representing an example of a variation of the whole-body controlling system for combat game of the present invention.

Also, as an example of a variation of the present invention, and as illustrated in FIG. 3, the upper left side sensing area (14) and the upper right side sensing area (12) are constituted automatically in front of the game user when using a diffusion reflection type optical sensor and operating the diffusion reflection type optical sensor used in the upper left side sensor signal generator (40) and the upper right-side sensor signal generator (42) from the lower front side to the upper front side of the feet plate regulator (36).

Further, when widening or narrowing the scope of the sensing areas, the intensity of the diffusion reflection type optical sensor can be easily regulated.

In order to render signals furnishing left and right fist movement and operate and to move image appearing on the monitor via left and right foot movement by installing the upper left-side sensor signal generator (40) and the upper right-side sensor signal generator (42) for the aforementioned automatic operation from the lower to upper side, the lower left sensing area (16) and lower right sensing area (20) are constituted when installing the lower left side curtain type sensing signal generator (6) and the lower right side curtain type sensing signal generator (30) to be operated from the left/right side to the center.

Moreover, the example of variation of the present invention may constitute the shielding unit for prohibiting successive movement (22) in the area coming in touch with and the upper right-side sensor signal generator (42) and the upper left-side sensor signal generator (40) in the center. Or it matters little to the signals even if the next movement is automatically not operated when continuant signals are generated without stop after generation of signals from the upper right-side sensor signal generator (42) and the upper left-side sensor signal generator (40).

If not being blocked as the aforementioned method, the shielding unit for prohibiting successive movement can be constituted between the upper left-side sensor signal generator (40) and the upper right-side sensor signal generator (42) to detect thereof.

The shielding unit for prohibiting successive movement (22) is constituted in the upper side of any one of the lower left-side curtain type sensing signal generator (6) and the lower right-side curtain type sensing signal generator (30), and the passing through of the fists and feet in a stretched state is detected by the working of the shielding unit for prohibiting successive movement (22).

In a case when the stretched arms are not folded back and stretched out again, it is possible to constitute in order not to render action to the image by false motion with program.

Accordingly, the game user should perform the correct movement in order to enjoy the game which characterizes the present invention with further increased exercise amount to that extent.

The present invention describes in a limited manner that arms and feet are used and to be installed in front of the feet plate regulator (36). Nevertheless, the present invention is not restricted as such, which is possible not only to build and use sensing areas in the sector such as head, etc., but also to install and use the feet plate regulators (36) in all directions.

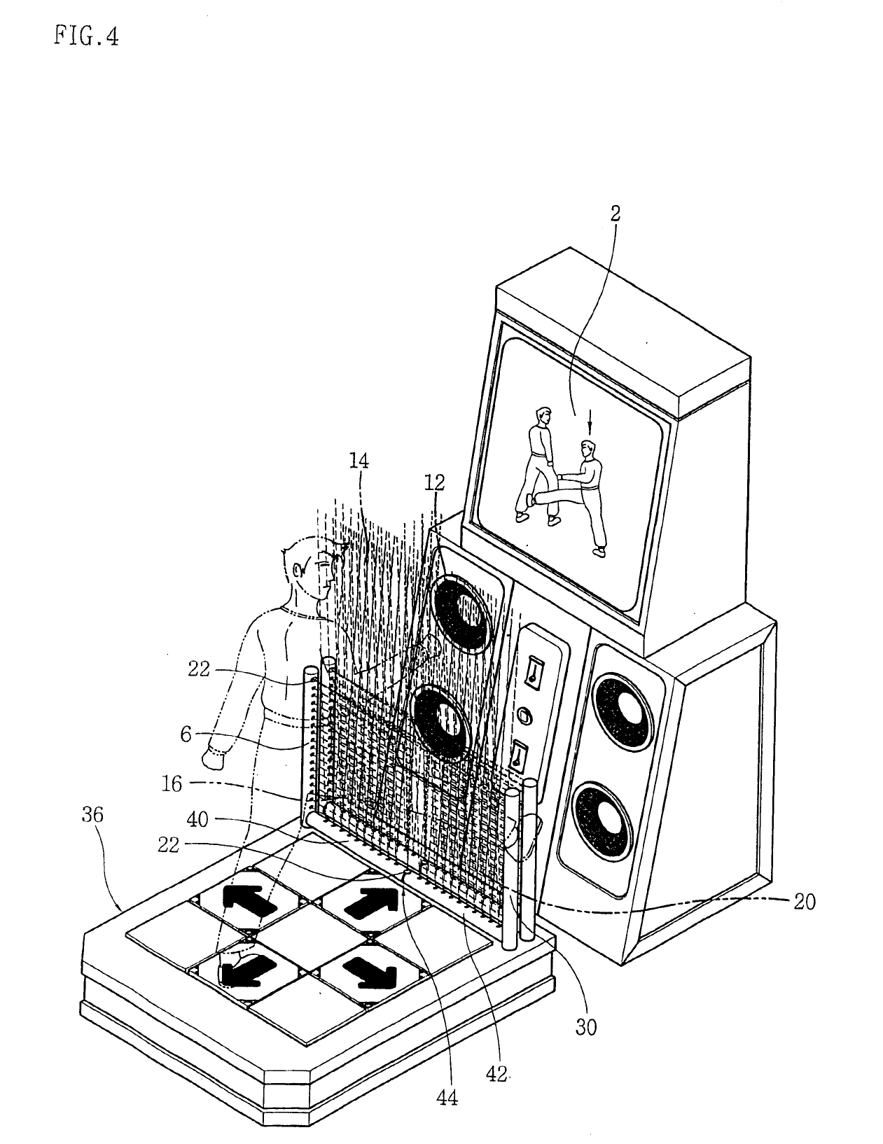

FIG. 4 is a drawing showing the state of the dually built whole-body controlling system for combat game of the present invention.

Furthermore, as shown in FIG. 4, the left side curtain-type sensing signal generator having left side sensing area and the right side curtain-type sensing signal generator having right side sensing are constituted to be overlapped in double layers. Thus, it is easy to urge the accurate realization of movement of stretching and folding arms.

Accordingly, due to the above double constitution, the game user should pass the two curtain screens to be able to render signals for moving the visual images. To such extent, the movement becomes accurate.

Moreover, the detailed description of the present invention sets forth in relation to a combat game in limited manner. Nevertheless, the present invention is not only restricted as such, but also can surely be applicable to and used in the games controllable by any one of feet or hands such as soccer or volleyball, etc.

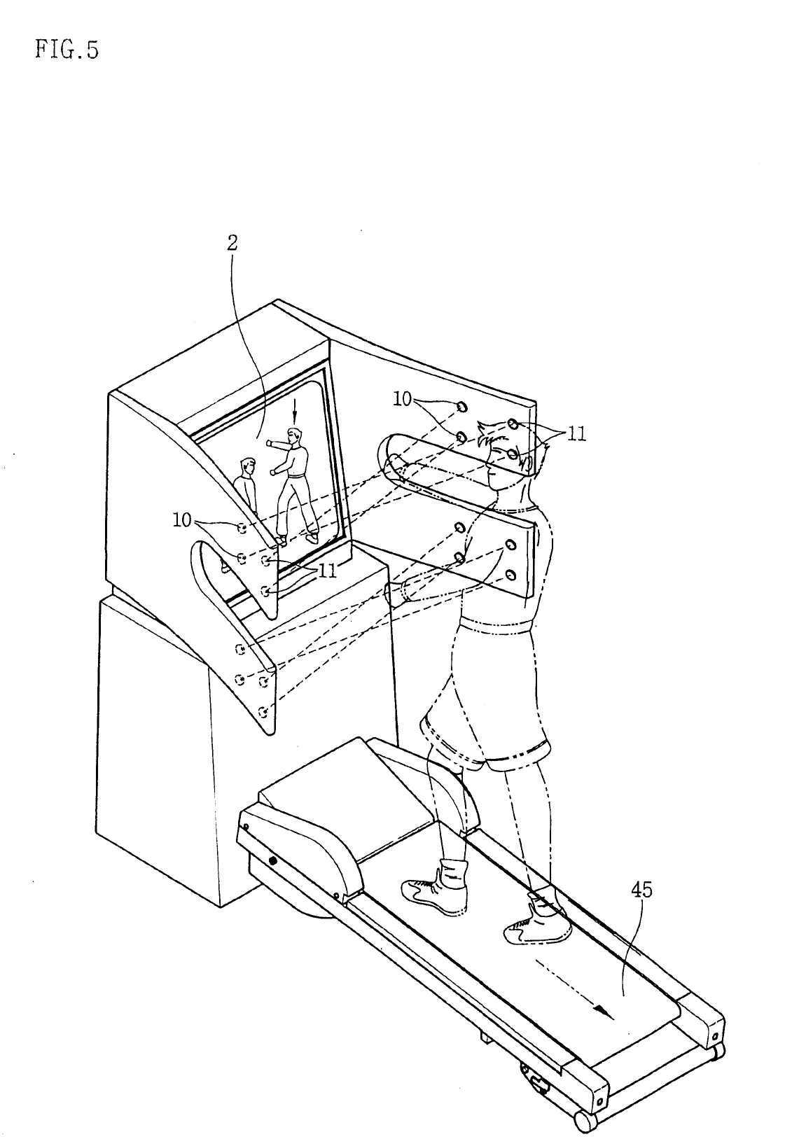

FIG. 5 is a drawing displaying a feet plate regulator that is a running machine among the whole-body controlling system for combat game of the present invention.

As in FIG. 5, unlike the feet plate regulator having a function of changing the direction of the visual image appearing on the front of the monitor (2) as in the example of the present invention, a revolution speed detecting sensor (not illustrated) can be attached to a running machine (45) and be used in order for game user to enjoy the combat game while jogging.

Thus, once the game user starts to jog on the running machine (45), the revolving speed is detected by the revolution speed detecting sensor, and signals are generated to let the image of the game run.

Also, it is needless to say that the present invention can be applicable not only to combat game but also to games involving running such as soccer game, etc.

The light receiving unit (10) and the light emitting unit (11) of the curtain type sensing means constituted on the front of the monitor (2) are built to operate in crisscross at the left and right sides. Thus, more accurate movement is to be performed.

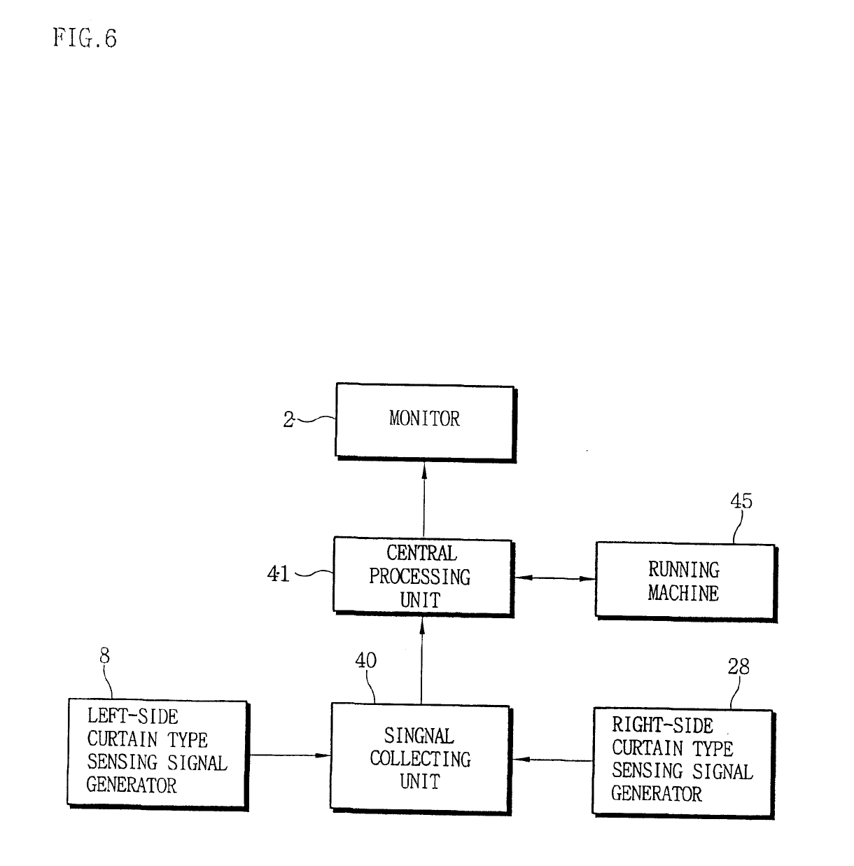

FIG. 6 is a block diagram displaying the whole-body controlling system for combat game of the present invention.

When the game user jogs on the running machine (45), the signals that detect the jogging speed by the revolution speed detecting sensor (note illustrated) are instantly transmitted to the central processing unit (41).

The signals generated from the running machine (45) allows the running in a speed for the image appearing on the monitor (2) to be the same, and on the other hand, the revolving speed of the running machine (45) can be arbitrarily controlled to be fast appropriate to the speed of the game at the central processing unit (41) of the game system. Thus, the present invention is characterized in that the jogging speed of the game user can be increased and decreased.

The signals generated from the left side curtain type sensing signal generator (8) and the right side curtain type sensing signal generator (28) to move the image appearing on the monitor (2) are also transmitted to the signal collecting unit (40).

Accordingly, after concurrently collecting the signals generated via speed from game user's jogging and signals generated from the sensing area formed on the front by signals transmitted to the signal collecting unit (40), the signals are instantly transmitted to the central processing unit (41).

The signals transmitted to the central processing unit (41) are processed to move the image appearing on the monitor (2).

As aforementioned, the whole-body controlling system for combat game of the movement of the game user swinging his arms and feet in a stretched state without folding them back is not allowed to play the game. Thus, the present invention has an effect of eliminating the unbalance/imbalance generated from game user's exercise.

Industrial Applicability

Hence, as described in details in the above, the whole-body controlling system for combat game of the present invention requires use of the entire body including arms and legs to proceed the game. In this regard, the present invention has a trait that may enhance game user's amount of physical exercise. Accordingly, in addition to electronic games, the system of the present invention is applicable to fitness exercise machines which adopt games.

What is claimed is

1. A whole body control system for combat game controlling image appearing on the monitor, which comprises;
feet plate regulators regulating the movement of visual image appearing on the monitor by feet; and
a curtain type sensing means forming shielding screen for sensing the stretching motion of game user's hands or feet on the front side of said feet plate regulator.

2. A whole body control system for combat game according to claim 1, wherein said sensing means comprises a upper curtain type sensing signal generator on the upper side and a lower curtain type sensing signal generator on the lower side.

3. A whole body control system for combat game according to claim 2, wherein said sensing means further comprises a shielding unit for prohibiting successive movement, which is formed between said upper curtain type sensing signal generator and said lower curtain type sensing signal generator, in order for signals of said upper curtain type sensing signal generator and said lower curtain type sensing signal generator not to be generated continuously when the game user's arms or feet are moved in a stretched state.

4. A whole body control system for combat game according to claim 1, wherein said sensing means further comprises;
a left-side curtain type sensing signal generator (8) formed on the left-side of said feet plate regulator (36), which is to be operated when the game user stretches his/her hands or feet; and
a right-side curtain type sensing signal generator (28) formed on the left-side of said feet plate regulator (36), which is to be operated when the game user stretches his/her hands or feet.

5. A whole body control system for combat game according to claim 4, wherein said sensing means further comprises a shielding unit for prohibiting successive movement which is formed between said upper curtain type sensing signal generator and said lower curtain type sensing signal generator to detect when the game user's arms or feet are moved in a stretched state.

6. A whole body control system for combat game according to claim 5, wherein said right-side sensing signal generator (28), said left-side sensing signal generator (8) and said shielding unit for prohibiting successive movement (22) are provided with an optical sensor which is selected from the group consisting of transmission type optical sensor, feedback reflection type optical sensor or diffusion reflection type optical sensor.

7. A whole body control system for combat game according to claim S or claim 6, wherein said right-side sensing signal generator (28) is divided into a upper right-side curtain type sensing signal generator (26) and a lower right-side curtain type sensing signal generator (30), and said left-side curtain type sensing signal generator (8) is divided into a upper left-side curtain type sensing signal generator (32) and a lower left-side curtain type sensing signal generator (6).

8. A whole body control system for combat game according to claim 7, wherein said shielding unit for prohibiting successive movement is formed either between said upper right-side curtain type sensing signal generator (26) and said lower right-side curtain type sensing signal generator (30) or between said upper left-side curtain type sensing signal generator (32) and said lower left-side curtain type sensing signal generator (6).

9. A whole body control system for combat game according to claim 1, wherein said sensing means comprises a curtain type sensing signal generator (44) having a right-side sensing area and a left-side sensing area which are to be operated when the game user stretches his/her hands or feet, on the lower side of the front side of said feet plate regulator (36).

10. A whole body control system for combat game according to claim 9, wherein said sensing means comprises;
a left-side lower sensing signal generator (6) having a left-side lower sensing area to be operated by left foot movement on the left side of said feet plate regulator (36); and
a right-side lower sensing signal generator (30) having a right-side lower sensing area to be operated by right foot movement on the right side of said feet plate regulator (36).

11. A whole body control system for combat game according to claim 10, wherein said sensing means further comprises a shielding unit for prohibiting successive movement which is formed either on said left-side lower sensing signal generator (6) or on said right-side lower sensing signal generator (30).

12. A whole body control system for combat game according to claim 9 or claim 10, wherein said curtain type sensing signal generator (44) is composed of a upper left side sensing signal generator (40) and a upper right side sensing signal generator (42), and a shielding unit for prohibiting successive movement (22) formed therebetween.

13. A whole body control system for combat game according to claim 12, wherein said curtain type sensing signal generator (44), said lower left side sensing signal generator (6) and said lower right side sensing signal generator (30) are provided with an optical sensor which is selected from the group consisting of transmission type optical sensor, feedback reflection type optical sensor or diffusion reflection type optical sensor.

14. A whole body control system for combat game according to claim 1 or claim 9, wherein said curtain type sensing means is overlapped in double layers.

15. A whole body control system for combat game according to claim 14, wherein a light receiving unit and a light emitting unit of said doubly overlapped curtain type sensing means is crisscrossed to each other on the left and right sides.

16. A whole body control system for combat game according to claim 1 or claim 2, wherein said feet plate regulator comprises a feet plate regulator for DDR or a running machine having a revolution speed sensing sensor which detects the speed of revolution when the game user jogs.
